(19) United States
(12) Patent Application Publication
(10) Pub. No.: US 2025/0135799 A1
(43) Pub. Date: May 1, 2025

(54) NOTE PAD AND NOTE PAD PAGE THEREOF

(71) Applicant: KAISA USA, Inc., McKenney, VA (US)

(72) Inventor: WEN HUA, Chester, VA (US)

(21) Appl. No.: 18/540,160

(22) Filed: Dec. 14, 2023

Related U.S. Application Data
(60) Provisional application No. 63/546,097, filed on Oct. 27, 2023.

(51) Int. Cl. B42F 21/12; B42C 9/00; B42D 15/00

(52) U.S. Cl. CPC B42F 21/12; B42C 9/0006; B42D 15/0006

(57) ABSTRACT

The instant invention provides a paper product providing the index cards in a binding. The instant invention provides the flexibility of individual index card for storage once the information is written on it. User has the option to tear the index card out of the note pad once the user finished writing the information on the index card, and the individual index card can be stored in a traditional index card box along with other index cards.

### CROSS REFERENCE TO RELATED PATENT APPLICATION

This patent application is based on a provisional patent application No. 63/546,097 filed on Oct. 27, 2023.

### FIELD OF THE INVENTION

The instant invention relates to a paper product, and more particularly, to a note pad with index cards.

### BACKGROUND OF THE INVENTION

Index cards are well-known paper products for storing and sorting information. Although computer systems have largely taken the storing and sorting functions in a modern office environment, the paper index card still has its role for people preferring hand-on operation for reviewing and recording information, especially in a green and out-of-electricity environment.

However, traditional index cards are uniformly sized. If people want to write down more information for a particular index, two or more separate index cards are need. Hence, it is desired to have index cards with flexibilities, yet when these index cards are bound, they still have the same lengths and widths. Thus, they can be placed in a traditional index card box.

### SUMMARY OF THE INVENTION

An objective of the instant invention is to provide a paper product with a flexible design of folding options. When these index cards are bound or piled together, they still have the same sizes. And for the particular index, only one index card page with multiple folded index cards is needed.

According to an embodiment of the instant invention, a note pad is provided. The note pad comprising a first note pad page, wherein said first note pad page includes a top margin, a first index card, and a second index card. Said first index card and said second index card are connected by a perforated line. Said top margin includes a punched hole. Said first index card includes a top perforated line for said top margin. Said top perforated line is in parallel to said first perforated line.

According to an embodiment of the instant invention, a note pad is provided. The note pad comprising a plurality of note pad pages, wherein each of said note pad page comprises a first index card and a second index card, wherein said first index card and said second index card are connected by a first perforated line, wherein the first index card includes a top margin with at least one hole.

According to an embodiment of the instant invention, an aforementioned note pad page is provided.

The instant invention provides a paper product providing the index cards in a binding. The instant invention provides the flexibility of individual index card for storage once the information is written on it. User has the option to tear the index card out of the note pad once the user finished writing the information on the index card, and the individual index card can be stored in a traditional index card box along with other index cards.

User can also keep the index card on the note pad, and as each page of the note pad includes several index cards separated by perforated lines, user can continuously write information on several consecutive index cards. User can also keep the index cards on the note pad as regular notes.

Each index card in the note pad can have lines or grids. Each index card can also be color coded; such that different index cards can have different colors, different pad pages can have different colors, different printed patterns can have different colors, or the combination of thereof. With different colors, user can category different information on each index card with different colors, and user can also associate each category with one particular color.

The note pad is glue bonded with pages of index cards. The top of each page also has a top margin for further secure the index card in case the glue bonding fails. In one embodiment, a hole is positioned at the top margin for working with a binder ring.

### BRIEF DESCRIPTION OF THE DRAWINGS

The advantages and spirit related to the instant invention can be further understood via the following detailed description and drawings.

FIG. 1 illustrates a side view of a note pad 100 in accordance with an embodiment of the instant invention.

FIG. 2 illustrates a perspective view of the note pad 100 in accordance with an embodiment of the instant invention.

FIG. 3A depicts a top view of the note pad page 130 according to an embodiment of the instant invention.

FIG. 3B depicts a top view of the note pad page 130 according to another embodiment of the instant invention.

FIG. 4 illustrates a perspective view of a note pad 100 according to an embodiment of this instant invention.

FIG. 5 depicts a perspective view of the note pad page 130 in accordance with an embodiment of the instant invention.

FIG. 6A depicts a perspective view of the note pad page 130 in accordance with an embodiment of the instant invention.

FIG. 6B depicts a perspective view of the note pad page 130 in accordance with another embodiment of the instant invention.

FIG. 7 illustrates a perspective view of the note pad 100 according to an embodiment of the instant invention.

### DETAILED DESCRIPTION OF THE PREFERRED EMBODIMENT

Some embodiments of the instant application are described in detail below. However, in addition to the description given below, the instant invention can be applicable to other embodiments, and the scope of the instant invention is not limited by such rather by the scope of the claims. Moreover, for better understanding and clarity of the description, some components in the drawings may not necessary be drawn to scale, in which some may be exaggerated related to others, and irrelevant. If no relation of two steps is described, their execution order is not bound by the sequence as shown in the flowchart diagram.

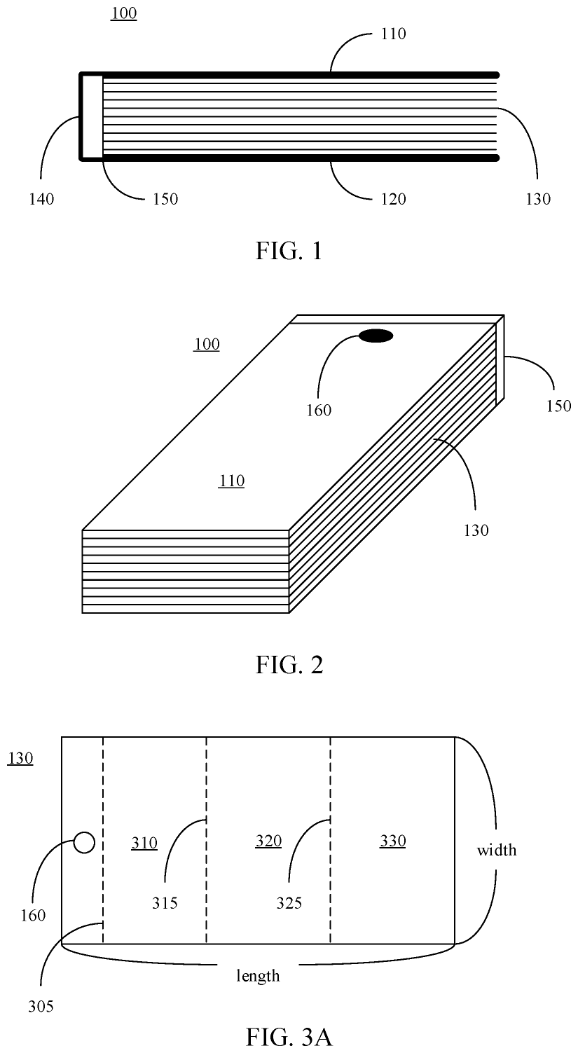

Please refer to FIG. 1, which illustrates a side view of a note pad 100 in accordance with an embodiment of the instant invention. The note pad 100 may comprises an optional front cover 110, an optional back cover 120, a plurality of note pad pages 130, an optional spine 140, and a glue layer 150 which glues the note pad pages 130 together. The thickness of the spine 140 is proportional to the number of the note pad pages 130.

In an embodiment, the front cover 110, the spine 140, and the back cover 120 may be made of one continuous sheet of paper. Alternatively, the front cover 110, the spine 140, and the back cover 120 may be made of separate sheets of papers which are also glued to the glue layer 150. Optionally, the front cover 110, the spine 140, and the back cover 120 are used to protect the note pad pages 130. Materials of the front cover 110, the spine 140, and the back cover 120 may be identical to the note pad pages 130. In some embodiments, at least one or any combination of the front cover 110, the spine 140, and the back cover 120 may be made of a paper thicker than the note pad pages 130.

Information of this note pad 100 such as brand name, product name, size and number of the note pad pages 130 may be printed on the front cover 110. Barcode, QR code, product code, and/or any information required by laws and regulations may be also printed on the front cover 110 or the back cover 120. In some cases, transparent plastic membranes are used to enclosure and to encapsulate the note pad 100 for further protection.

In an embodiment of the instant invention, the size of the note pad page is 9.75 inches by 5 inches. The number of note pad pages 130 is 240.

Please refer to FIG. 2, which illustrates a perspective view of the note pad 100 in accordance with an embodiment of the instant invention. In a top margin area closed to the spine 140, one punched hole 160 is presented for each of the note pad pages 130. As shown in FIG. 2, the front cover 110 also comprises the punched hole 160.

The single punched hole 160 may be located in the middle of the width of the note pad 100. Alternatively, the single punched hole 160 may be placed in other location of the top margin area. In other embodiments, there may be a plurality of punched holes 160 in each of the note pad pages 130 or in the front cover 110. The at least one punched hole 160 does not touch the glue layer 150.

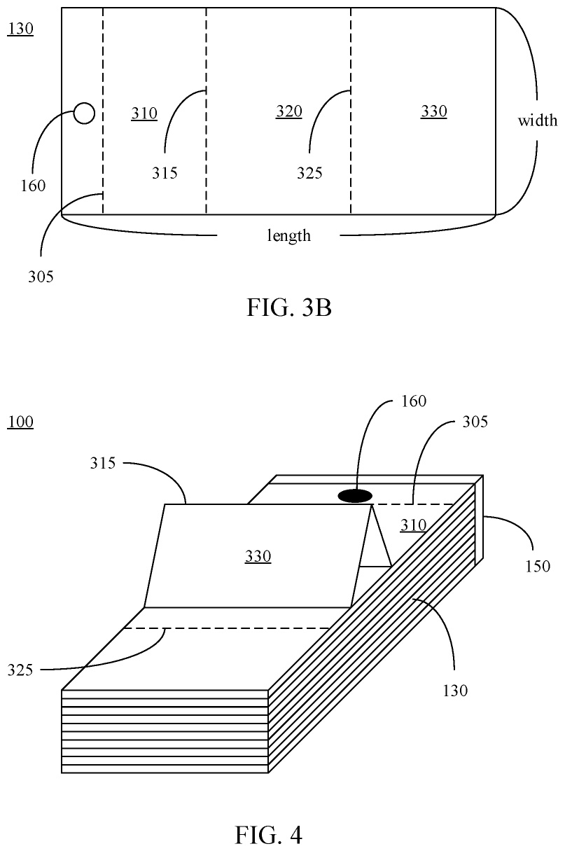

Each of the note pad page 130 may be tear out of the note pad 100. Please refer to FIG. 3A, which depicts a top view of the note pad page 130 according to an embodiment of the instant invention. From left to right, the note pad page 130 contains three parts 310, 320, and 330. The first part 310 is an index card with a top margin. The first part 310 may be referred to as the first index card 310. For example, the size of the first part 310 may be 3.75 inches by 5 inches. There exists at least one punched hole 160 in the top margin of the first part for binding.

As shown in FIG. 3A, there are two consecutive parts 320 and 330 joining the bottom of the first part 310. However, the note pad page 130 may include more than two consecutive parts. The second part 320 next to the first index card 310 may be referred to as the second index card 320. Similarly, the third part 330 next to the second index card 320 may be referred to as the third index card 330.

An optional top perforated line 305 may be placed below the top margin of the first index card. A first perforated line 315 is rested between the first index card 310 and the second index card 320. A second perforated line 325 is rested between the second index card 320 and the third index card 330. If there are more consecutive parts, there would be perforated lines between the consecutive parts. The perforated lines may be referred to as tearing lines.

The lengths of these consecutive parts may be identical. Similarly, the widths of index cards may be identical, too. For example, the size of the second index card 320 may be 3 inches by 5 inches. So does the size of the third index card 330. The length of the first index card, 3.75 inches, is longer than the lengths of the consecutive index cards 320 and 330, i.e., 3 inches. However, in alternative embodiments, the lengths of the consecutive index cards may be different. In some embodiments, the length of the first index card 310 is the longest among the index cards of the note pad page 130.

Although the lengths of these index cards are shorter than the width of these index cards in the embodiment as shown in FIG. 3A, the instant invention does not limit to that. In other words, the lengths of these index cards may be longer than the width in some embodiments.

Please refer to FIG. 3B, which depicts a top view of the note pad page 130 according to another embodiment of the instant invention. Comparing with the embodiment as shown in FIG. 3A, the difference between these two embodiments is that the lengths of the index cards 310, 320, and 330 of the same note pad page 130 are identical. In an example, the top perforated line 305 may be omitted.

Please refer to FIG. 4, which illustrates a perspective view of a note pad 100 according to an embodiment of this instant invention. Please be noted that the front cover 110 is absent in FIG. 4. The optional front cover 110 may not be available. In some cases, the front cover 110 may be detached from the spine 140 and the glue layer 150. Similarly, the optional back cover 120 may not be available. In some cases, the back cover 120 may be detached from the spine 140 and the glue layer 150. Moreover, the optional spine 140 may be also absent in some embodiments.

Essentially, the note pad 100 must include the multiple note pad pages 130 which are attached to the glue layer 150. Each of the note pad pages 130 may be detachable from the glue layer 150. For example, when the first two note pages 130 are still attached to the glue layer 150, user may tear the underlying third note pages 130 off the glue layer 150. In order to help the rest of the note pad pages 130 attaching to the glue layer 150, an unshown binder ring may be used to bind the note pad 100 via the punched holes 160. Alternatively, user may tear the note pages 130 off along the top perforated line 305 such that the top margin of the first index card 310 still attaches to the glue layer 150, i.e., the note pad 100. Leaving the top margins attached to the note pad 100 helps the integration of the note pad 100.

As shown in FIG. 4, the second and the third index cards 320 and 330 may be folded along the perforated lines 315 and 325, respectively. For an index, user may write down information on the first index card 310 of the note pad page 130. If the space of the first index card 310 is not enough for the information, additional information may be written down on the second index card 320. Even if the space of the first and the second index cards 310 and 320 are not enough, user may take advantage of the third index cards 330. In short, user can use the space of the consecutive parts of the note pad page 130.

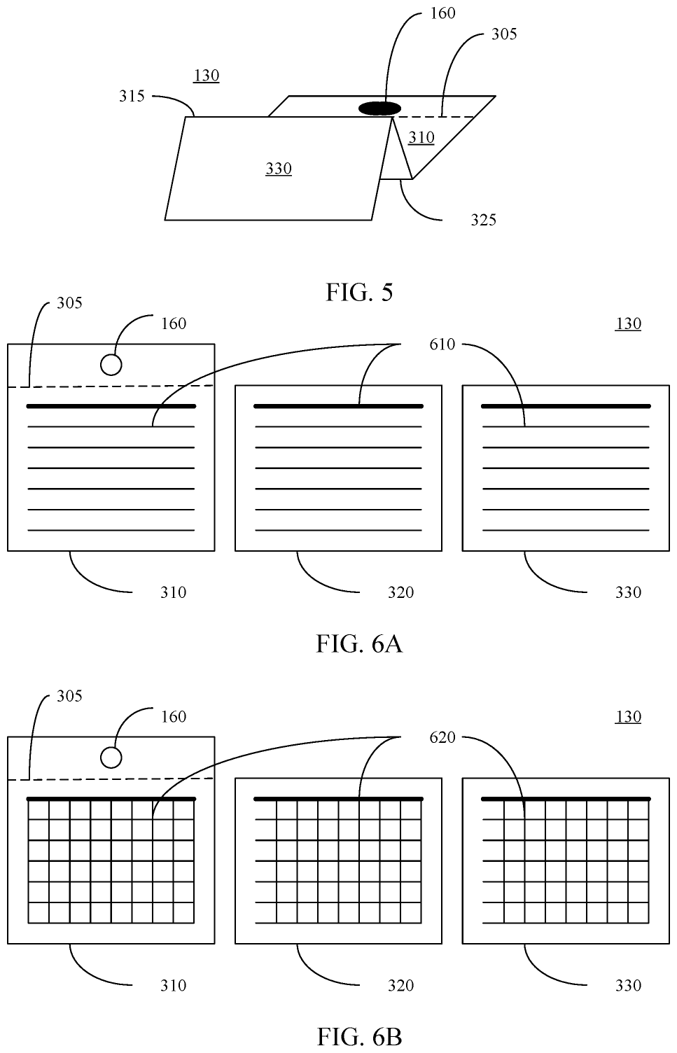

Please refer to FIG. 5, which depicts a perspective view of the note pad page 130 in accordance with an embodiment of the instant invention. As shown in FIG. 6A, the note pad page 130 separated from the note pad 100 may be added to another binder ring. The consecutive index cards 320 and 330 of the separated note pad page 130 can be folded such that the length of the folded note pad page 130 is approximately identical the length of the first index card 310.

In case that the third index card 330 is also detached from the note pad page 130, the second index card 320 can be folded to the first index card 310 such that the length of the folded note pad page 130 is approximately identical the length of the first index card 310. In case that the second index card 320 and the third index card 330 are detached from the first index card 310. The length of the sole first index card 310 is approximately identical the folded note pad pages 130 with one or more folded consecutive index cards. When collected in a pile or an index box, or bound in a ring via the holes 160, these separate and folded note pad pages 130 and the first index cards 310 can be stacked precisely and uniformly.

Please refer to FIG. 6A, which depicts a perspective view of the note pad page 130 in accordance with an embodiment of the instant invention. Please refer to FIG. 6B, which depicts a perspective view of the note pad page 130 in accordance with another embodiment of the instant invention. These index cards 310 through 330 are printed with lines 610 as shown in FIG. 6A. Alternatively, in the embodiment as shown in FIG. 6B, these index cards 310 through 330 may be printed with grids 620. The lines 610 or the grids 620 may be printed on one or both sides of these index cards 310 through 330. The printed patterns of these index cards may be color coded.

The length 620 of the consecutive index cards 320 and 330 is shorter than the length of the first index card 310. The separate consecutive index cards 320 and 330 which have no hole 160 may be used as note papers.

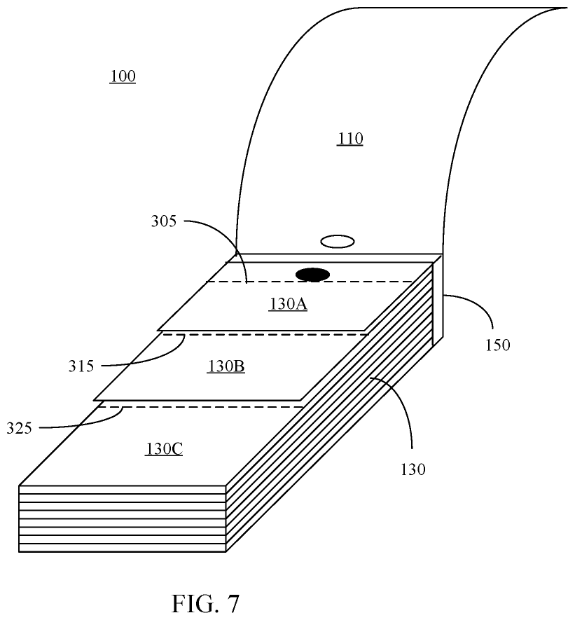

Please refer to FIG. 7, which illustrates a perspective view of the note pad 100 according to an embodiment of the instant invention. As shown in FIG. 7, the note pad 100 is open. The first note pad page 130A is short of the consecutive index cards 320 and 330. The underlying second note pad page 130B is short of the third index card 330. Hence, the second index card 320 of the second note pad page 130B and the third index card 330 of the underlying third note pad page 130C can be shown in FIG. 7.

The instant invention provides a paper product providing the index cards in a binding. The instant invention provides the flexibility of individual index card for storage once the information is written on it. User has the option to tear the index card out of the note pad once the user finished writing the information on the index card, and the individual index card can be stored in a traditional index card box along with other index cards.

User can also keep the index card on the note pad, and as each page of the note pad includes several index cards separated by perforated lines, user can continuously write information on several consecutive index cards. User can also keep the index cards on the note pad as regular notes.

Each index card in the note pad can have lines or grids. Each index card can also be color coded; such that different index cards can have different colors, different pad pages can have different colors, different printed patterns can have different colors, or the combination of thereof.

With different colors, user can category different information on each index card with different colors, and user can also associate each category with one particular color.

The note pad is glue bonded with pages of index cards. The top of each page also has a top margin for further secure the index card in case the glue bonding fails. In one embodiment, a hole is positioned at the top margin for working with a binder ring.

According to an embodiment of the instant invention, a note pad is provided. The note pad comprising a first note pad page, wherein said first note pad page includes a top margin, a first index card, and a second index card. Said first index card and said second index card are connected by a perforated line. Said top margin includes a punched hole. Said first index card includes a top perforated line for said top margin. Said top perforated line is in parallel to said first perforated line.

Preferably, said note pad is glue bonded.

Preferably, said first note pad page is detachable from said note pad.

According to an embodiment of the instant invention, a note pad is provided. The note pad comprising a plurality of note pad pages, wherein each of said note pad page comprises a first index card and a second index card, wherein said first index card and said second index card are connected by a first perforated line, wherein the first index card includes a top margin with at least one hole.

Preferably, in order to glue the plurality of note pad pages together and to make them detachable individually, said note pad further comprises: a glue layer, wherein said glue layer glues said top margins of said plurality of note pad pages together.

Preferably, in order to protect said glue layer, said note pad further comprises a spine, wherein said glue layer glues said top margins of said plurality of note pad pages and said spine together.

Preferably, in order to protect said plurality of note pad pages from top or from bottom, said note pad further comprises at least one of following: a front cover, wherein said front cover is on top of said plurality of note pad pages; and a back cover, wherein said back cover is at bottom of said plurality of note pad pages.

Preferably, in order to manufacture more easier, said spine and said front cover are made of a continuous sheet of paper.

Preferably, in order to manufacture more easier, said spine and said back cover are made of a continuous sheet of paper.

Preferably, in order to provide more consecutive index cards for each note pad page, each of said note pad page further comprises: a third index card, wherein said second index card and said third index card are connected by a second perforated line, wherein said first perforated line is in parallel with said second perforated line.

Preferably, in order to fold the consecutive index cards into one uniformed size, sizes of said second index card and said third index card are identical.

Preferably, in order to provide more consecutive index cards for each note pad page, each of said note pad page further comprises: a fourth index card, wherein said third index card and said fourth index card are connected by a third perforated line, wherein said first perforated line is in parallel with said third perforated line.

Preferably, in order to fold the consecutive index cards into one uniformed size, sizes of said second index card, said third index card, and said fourth index card are identical.

Preferably, in order to be bound via said hole, a length of said first index card is longer than a length of said second index card, wherein a width of said first index card is identical to a width of said second index card.

Preferably, in order to make a wider index card, a length of said first index card is shorter than a width of said first index card.

Preferably, in order to make the binding force applied to the first index card even, said hole is in the middle of said top margin. Preferably, in order to keep the top margin attaching to the glue layer, said first index card includes a top perforated line for said top margin. Said top perforated line is in parallel to said first perforated line.

Preferably, in order to make user easier to format the writing, said note pad page is printed with one or any combination of following patterns: lines and grids.

Preferably, in order to make user easier to format the writing, said pattern printed on said note pad page is color coded.

Preferably, in order to make user easier to use double sides of the note pad pages, said pattern are printed on both sides of said note pad page.

Preferably, in order to protect said note pad pages, said front cover and said back cover are thicker than said note pad page.

Preferably, in order to bind the whole note pad together, said front cover and said back cover includes holes, respectively. Said holes of said front cover and said back cover are positioned corresponding to said holes of said plurality of note pad pages.

Preferably, in order to protect the note pad pages, the note pad further comprises transparent membranes, which said transparent membranes encapsulate said plurality of note pad pages.

According to an embodiment of the instant invention, a note pad page is provided.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A note pad, comprising:
a plurality of note pad pages, wherein each of said note pad page comprises a first index card and a second index card,
wherein said first index card and said second index card are connected by a first perforated line,
wherein the first index card includes a top margin with at least one hole.

2. The note pad as claimed in claim 1, further comprises:
a glue layer, wherein said glue layer glues said top margins of said plurality of note pad pages together.

3. The note pad as claimed in claim 2, further comprises:
a spine, wherein said glue layer glues said top margins of said plurality of note pad pages and said spine together.

4. The note pad as claimed in claim 3, further comprises at least one of following:
a front cover, wherein said front cover is on top of said plurality of note pad pages; and
a back cover, wherein said back cover is at bottom of said plurality of note pad pages.

5. The note pad as claimed in claim 4, wherein said spine and said front cover are made of a continuous sheet of paper.

6. The note pad as claimed in claim 4, wherein said spine and said back cover are made of a continuous sheet of paper.

7. The note pad as claimed in claim 1, wherein each of said note pad page further comprises:
a third index card, wherein said second index card and said third index card are connected by a second perforated line,
wherein said first perforated line is in parallel with said second perforated line.

8. The note pad as claimed in claim 7, wherein sizes of said second index card and said third index card are identical.

9. The note pad as claimed in claim 7, wherein each of said note pad page further comprises:
a fourth index card, wherein said third index card and said fourth index card are connected by a third perforated line,
wherein said first perforated line is in parallel with said third perforated line.

10. The note pad as claimed in claim 1, wherein sizes of said first index card and said second index card are different.

11. The note pad as claimed in claim 1, wherein a length of said first index card is longer than a length of said second index card, wherein a width of said first index card is identical to a width of said second index card.

12. The note pad as claimed in claim 1, wherein a length of said first index card is shorter than a width of said first index card.

13. The note pad as claimed in claim 1, wherein said hole is in the middle of said top margin, wherein said first index card includes a top perforated line for said top margin, wherein said top perforated line is in parallel to said first perforated line.

14. The note pad as claimed in claim 1, wherein each of said plurality of note pad pages is printed with one or any combination of following patterns:
lines; and
grids.

15. The note pad as claimed in claim 14, wherein said pattern printed on each of said plurality of note pad pages is color coded.

16. The note pad as claimed in claim 14, wherein said pattern are printed on both sides of said note pad page.

17. The note pad as claimed in claim 1, wherein each of said plurality of pad pages is color coded, or each of said first index card and said second index card is color coded.

18. The note pad as claimed in claim 4, wherein said front cover and said back cover are thicker than said note pad page.

19. The note pad as claimed in claim 4,
wherein said front cover includes at least one hole,
wherein said back cover includes at least one hole, and
wherein said holes of said front cover and said back cover are positioned corresponding to said holes of said plurality of note pad pages.

20. The note pad as claimed in claim 1, further comprises:
transparent membranes, which said transparent membranes encapsulate said plurality of note pad pages.
